(19) United States
(12) Patent Application Publication
(10) Pub. No.: US 2008/0282024 A1
(43) Pub. Date: Nov. 13, 2008

(54) Management of erase operations in storage devices based on flash memories

(76) Inventors: Sudeep Biswas, Delhi (IN); Angelo Di Sena, Castello di Cistema (NA) (IT); Domenico Manna, Acerra (NA) (IT)

Correspondence Address: GRAYBEAL, JACKSON, HALEY LLP, 155 - 108TH AVENUE NE, SUITE 350, BELLEVUE, WA, 98004-5973, US

(21) Appl. No.: 11/801,742

(22) Filed: May 9, 2007

(51) Int. Cl. G06F 12/02; G06F 12/06; G06F 12/08

(52) U.S. Cl. 711/103; 711/162; 711/166

(57) ABSTRACT

A method of freeing physical memory space in an electrically alterable memory that includes a plurality of physical memory blocks includes a plurality of physical memory pages. Each physical memory block may be individually erased as a whole, and which memory is used to emulate a random access logical memory space including a plurality of logical memory sectors by storing updated versions of a logical memory sector data into different physical memory pages. The method includes causing a most recent version of multiple versions of logical memory sector data, stored in physical pages of at least one physical memory block, to be copied into an unused physical memory block, marking the at least one physical memory block, and when the electrically alterable memory is idle, erasing the marked physical memory block.

### CROSS REFERENCE TO RELATED APPLICATIONS

This application is related to U.S. patent application Ser. No. ______ entitled WEAR LEVELING IN STORAGE DEVICES BASED ON FLASH MEMORIES AND RELATED CIRCUIT, SYSTEM, AND METHOD (Attorney Docket No. 2110-251-03), ______ entitled RESTORING STORAGE DEVICES BASED ON FLASH MEMORIES AND RELATED CIRCUIT, SYSTEM AND METHOD (Attorney Docket No. 2110-252-03), ______ entitled GARBAGE COLLECTION IN STORAGE DEVICES BASED ON FLASH MEMORIES (Attorney Docket No. 2110-254-03), which have a common filing date and owner and which are incorporated by reference.

### TECHNICAL FIELD

Embodiments of the present invention relate to the field of data storage in data processing systems, and to storage devices. More specifically, the embodiments of the present invention relate to the management of erase operations in storage devices based on flash memories, particularly flash memories used to emulate hard disks.

### BACKGROUND

Storage devices based on flash memories have become very attractive in recent years. For example, they are commonly used as mass-storage memories (also known as solid-state mass memories) in several data processing systems, in substitution of, or in addition to, standard storage devices like hard disks. These storage devices are compact, robust and feature low power consumption. Therefore, they are advantageous especially in portable systems (such as in mobile telephones), which are typically battery-powered.

Every flash memory used to implement the above-mentioned storage devices can be erased only in blocks of memory having a relatively large size (for example, 16-32 Kbytes). Therefore, once data has been written into the flash memory, this data cannot be updated any longer, unless the whole corresponding block is erased.

In order to emulate operation of a random access device such as a standard hard disk, a translation layer is provided on top of the flash memory. The translation layer in particular manages an update of the data stored in the flash memory by writing a new version of the data into a different area of the flash memory, and updating corresponding mapping information that, when the data are to be accessed, allows accessing the new data version instead of the old one.

In particular, the translation layer translates a data erase command into a write operation into a different flash memory area.

For reusing the memory space occupied by old versions of data that have been previously updated and rewritten in different areas of the flash memory, two or more memory blocks containing such old versions of data are compacted into a new block. This is done following a so-called “garbage collection” procedure, according to which the valid data (i.e., the most recent version of the data, that are not old versions of updated data) stored in the blocks are copied into the new block and retained, and the blocks which contained the old data versions are erased to free memory space.

A problem of the storage devices based on flash memories is that the erase of a flash memory block requires a non-negligible amount of time, capable of delaying the operation of the storage device of an extent that is detrimental for the emulation of a random access memory. For example, in case the same portion of data needs to be continually updated at a high rate, each time the data is updated a new version thereof has to be written into a further portion of the memory. This generates a breed of old versions of the same data, that occupy memory space. When the garbage collection procedure is invoked, e.g., when a certain number of blocks storing the old versions of the data are full, these blocks need to be erased to free memory space, but this delays further updates of the data.

### SUMMARY

The Applicant has found that it is possible to avoid delaying the update of data stored in a storage device based on flash memories by postponing, in a garbage collection procedure, the operation of erasing the memory block(s) containing the old data versions to a time when the storage device is idle, and does not have to perform data write operations.

In other words, when the garbage collection procedure is invoked, the valid data are copied from the memory block(s) where they are stored into a new memory block, and the memory block(s) containing the obsolete data versions are labeled as erasable, but not necessarily erased at that time. The memory blocks labeled as erasable may thus enter a list of erasable memory blocks, that may be erased when the storage device is idle.

According to an aspect of the present invention, a method of freeing physical memory space in an electrically alterable memory that includes a plurality of physical memory blocks comprising a plurality of physical memory pages, each physical memory block being adapted to be individually erased as a whole, and which memory is used to emulate a random access logical memory space comprising a plurality of logical memory sectors by storing updated versions of a logical memory sector data into different physical memory pages, the method comprising:

causing a most recent version of multiple versions of logical memory sector data, stored in physical pages of at least one physical memory block, to be copied into an unused physical memory block;

marking the at least one physical memory block;

when the electrically alterable memory is idle, erasing the marked physical memory block.

### BRIEF DESCRIPTION OF THE DRAWINGS

The features and the advantages of the present invention will be best understood reading the following detailed description of exemplary and non-limitative embodiments thereof, a description that is to be read in conjunction with the accompanying drawings, in which:

FIG. 1 is a schematic block diagram of a mobile telephone wherein a solution according to an embodiment of the invention is applicable,

FIG. 2A is a high-level representation of a mass storage device included in the telephone of FIG. 1,

FIG. 2B is a functional scheme of the storage device,

FIG. 3 schematically shows a structure of a physical memory sector, in an embodiment of the present invention;

FIG. 4 shows an exemplary application of a solution according to an embodiment of the invention; and

FIGS. 5A-5C are diagrams describing the flow of activities relating to an implementation of a solution according to an embodiment of the invention.

### DETAILED DESCRIPTION

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

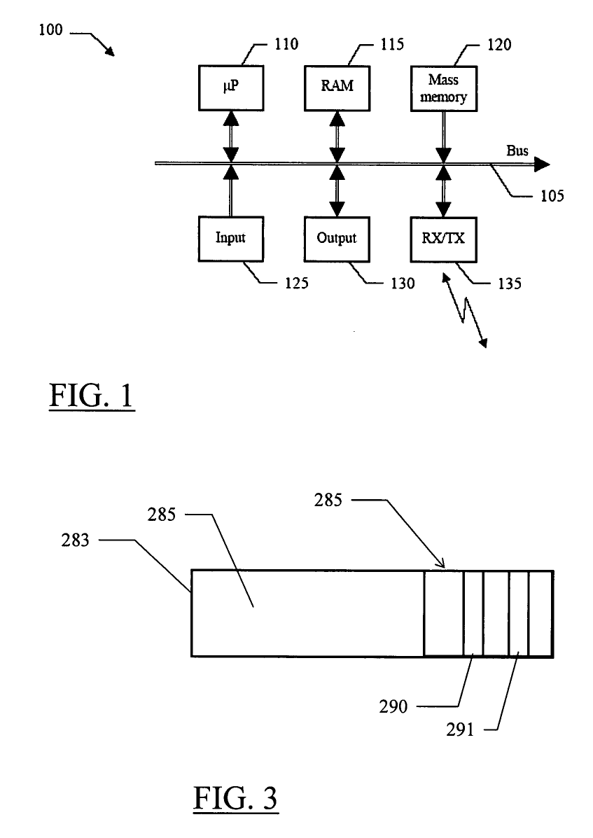

With reference to FIG. 1, a data processing system wherein an embodiment of the present invention is applicable is schematically shown. The data processing system includes in particular a mobile telephone 100 which comprises several functional units connected in parallel to a communication bus 105. In detail, a microprocessor 110 controls operation of the telephone 100; a RAM (Random Access Memory) 115 is directly used as a working memory by the microprocessor 110. Several peripheral units are further connected to the bus 105 (through respective drivers). Particularly, a mass storage device (mass memory) 120 is used to store data that should be preserved even when a power supply of the telephone 100 is off (for example, a firmware of the microprocessor 110, application programs, and personal information of a user of the telephone 100—such as an address book). Moreover, the telephone 100 includes input units 125 (for example, a keypad, a microphone, and a camera), and output units 130 (for example, a display and a loudspeaker). A transceiver (RX/TX) 135 implements any communications with an associated telephone exchange (not shown in the figure) to send and receive information.

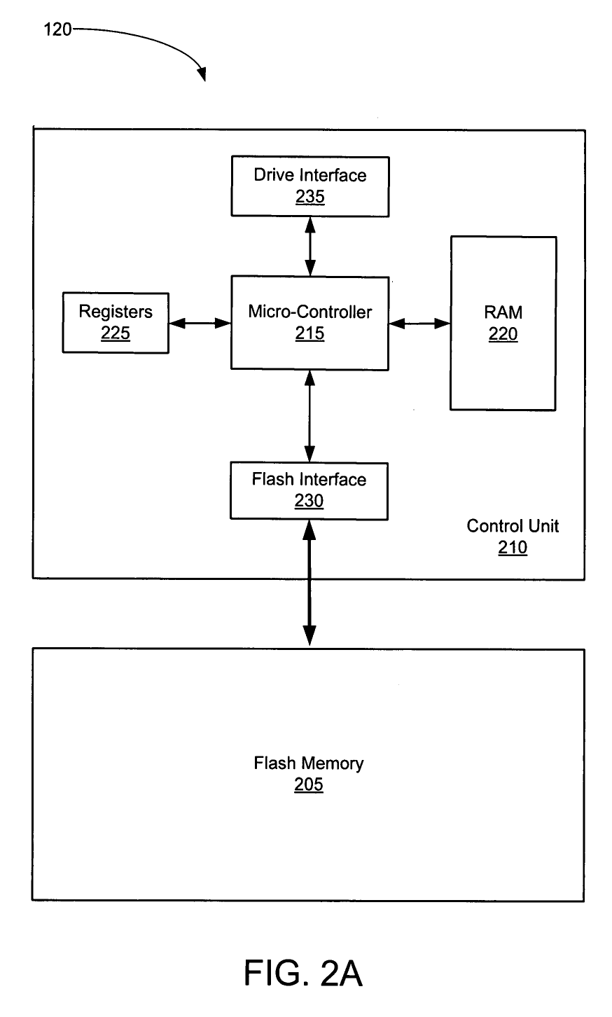

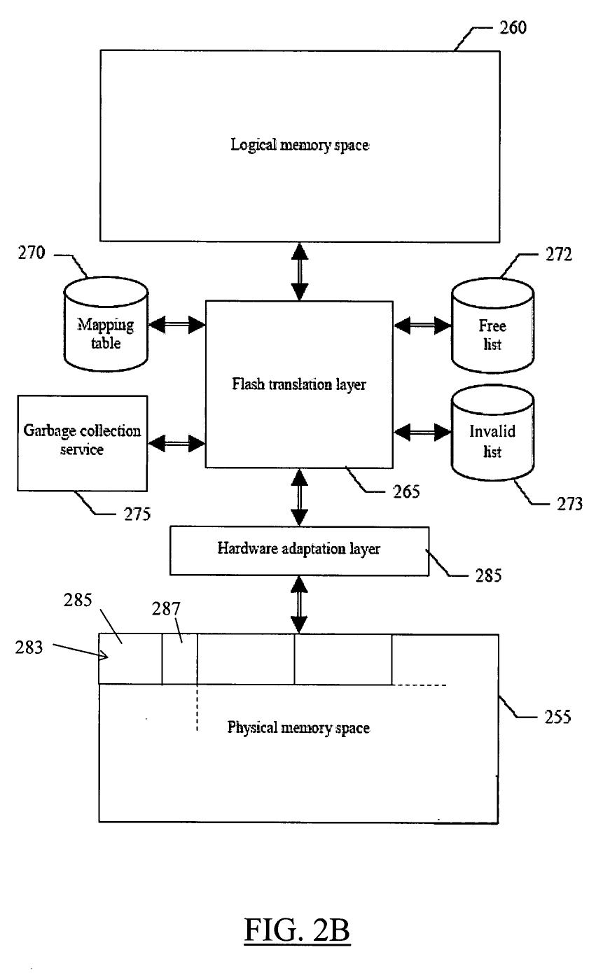

The mass storage device 120 is a solid-state mass memory; particularly, as depicted in FIG. 2A, the storage device 120 is based on a flash memory 205 and implements a “flash disk” simulating a standard hard disk of the type commonly used in PCs. The flash memory 205 includes a matrix of memory cells with NAND architecture (not shown in the figure). Memory cells of the flash memory 205 can be written and read by groups hereinafter referred to as “physical memory pages”. For example, each physical memory page may consist of 528 bytes. On the other hand, the memory cells cannot be erased by physical memory pages. Erasure of the memory cells is possible only by groups hereinafter referred to as “physical memory blocks,” which are far larger than physical memory pages. For example, each physical memory block may include 32 physical memory pages. Therefore, once the memory cells of a physical memory page have been programmed, so as to write the desired data into the physical memory page, the data stored in this physical memory page cannot be updated in a way that requires erasing one or more memory cells of the physical memory page (e.g., in a way that require changing a logical “0” stored in a cell into a logical “1”), unless the whole respective physical memory block is preliminarily erased. An update of the stored data that only involves the programming of one or more memory cells of the physical memory page, to change a logical “1” stored in this cell or cells into a logical “0”, is instead possible.

A control unit 210 manages the flash memory 205 so as to emulate a random access to the storage device 120. The control unit 210 is based on a micro-controller 215. The micro-controller 215 accesses a RAM 220 (being used as a working memory) and a series of registers 225. An interface (Flash interface) 230 couples the micro-controller 215 with the flash memory 205. Another interface (Drive interface) 235 instead couples the same micro-controller 215 with the driver of the telephone for the storage device 120 (not shown in the figure).

Operation of the micro-controller 215 is managed by firmware, which is for example stored in the flash memory 205 and then loaded (at least partially) into the RAM 220 when the micro-controller 215 is running. The firmware may be initially installed onto the flash memory 205 during the storage device manufacturing.

A functional scheme of the mass storage device 120 is illustrated in FIG. 2B. The flash memory 205 provides a physical memory space 255. The physical memory space 255 consists of the physical memory blocks 280 of the flash memory 205. As mentioned in the foregoing, the physical memory blocks are groups of memory cells that can be individually erased only as a whole. Each physical memory block is identified by a corresponding physical memory block number (for example, a binary code of 12 bits, enabling the access to up to 4096 different physical memory blocks). In turn, each physical memory block includes a plurality of physical memory pages, which can be individually programmed and read, but not individually erased. Each physical memory page is identified by a corresponding physical memory page offset within the physical block (the physical memory page offset may be a binary code of 4 bits, in the exemplary case wherein each physical block includes 32 physical pages).

The storage device 120 emulates a logical memory space 260. The logical memory space 260 consists of logical memory sectors (for example, each one of 512 bytes), which can be written (repeatedly to any value) and read individually. In other words, the data stored in a logical memory sector can be freely updated and, in particular, deleted. The logical memory sectors are grouped into logical memory blocks (for example, each one including 32 logical sectors). Each logical memory block is identified by a corresponding logical block number (for example, again a binary code of 12 bits, allowing the access to up to 4096 different logical memory blocks). Each logical memory sector is identified by a corresponding logical sector offset within the logical memory block (a binary code of 4 bits in the example at issue).

Different, successive versions of the data that have been stored in a logical memory sector are written into different physical memory sectors 283, corresponding to that logical memory sector. The size of a physical memory sector may for example correspond to the size of a physical memory page, in which case the size of a logical memory sector corresponds to that of a physical memory page. This is, however, not limitative to the present embodiment of the invention.

The physical memory sector includes a main storage area 285 for storing one version of the data that have been stored in a corresponding logical memory sector, and a spare storage area 287 for storing service information. In the example herein considered, the main storage area may be of 512 bytes, and the spare storage area may be of 16 bytes.

A Flash Translation Layer (FTL) 265 maps the logical memory space 260 onto the physical memory space 255. Particularly, each logical memory block is associated with one or more physical memory blocks, organized in a tree structure In a possible implementation, the generic logical memory block is associated with a physical memory block that defines a root node of the tree structure, and possibly with another physical memory block that defines a leaf node depending on the root node. The logical memory sectors of a logical memory block are written in succession into consecutive physical memory sectors of the associated physical memory block(s) The writing of the logical sectors starts from the root physical block, and then continues to the leaf physical block once the root physical block is full.

When the data of a logical memory sector are written into a physical memory sector, the logical memory sector data are stored into the main storage area of the physical memory sector. The spare storage area instead stores an indication of the corresponding logical memory sector (for example, its logical offset). The spare storage area of the first physical memory sector of each physical memory block is also used to store an indication of the corresponding logical memory block to which it is associated (for example, its logical block number), and an indication of the position of the physical memory block in the tree structure (i.e., root node or leaf node).

Since the physical memory sectors, after having been programmed, cannot be individually reprogrammed in a way that requires erasing one or more memory cells thereof, any time the data stored in a logical memory sector are updated, the new version of the data is actually written into another physical memory sector, which is then associated with that logical memory sector.

Even a logical memory sector data delete, for deleting the data previously stored in the logical memory sector, is thus implemented as a data write operation, writing the new version of the logical memory sector data into a different physical memory sector.

Alternatively, in an embodiment of the present invention, a logical memory sector data delete may be implemented by properly marking the physical memory sector where the previous version of the logical memory sector data was stored, without the need of performing a write of the new data version into a different physical memory sector. The physical memory sector may for example be marked by a flag, exploiting for example a byte 290 in the physical memory sector spare storage area, as shown in FIG. 3, which flag byte, when set to, e.g., 00h (h stands for hexadecimal notation), denotes that the data stored in the physical memory sector are to be considered as deleted. This allows saving physical storage space, and, as will be explained in the following, simplifies the garbage collection operations.

The FTL 265 manages a Logical-to-Physical (L2P) mapping table 270. The mapping table 270 associates each logical memory block with the corresponding root physical block and leaf physical block (if any). In turn, the mapping table 270 associates each written logical memory sector with the physical memory sector (in the root physical block or in the leaf physical block) wherein the last version of the logical memory sector data are stored. The mapping table 270 may be created during an initialization stage of the storage device, at its power-on (by reading the relevant information stored in the spare areas of the different physical sectors). The mapping table 270 is then maintained up-to-date according to the operations performed on the storage device.

The FTL 265 also manages a free physical blocks list 272. The free physical blocks list 272 indicates (by means of the physical memory block numbers) the physical memory blocks that are in an erased condition, and thus are available for writing data. The free physical blocks list 272 may be created during the initialization of the storage device at its power-on. The free physical blocks list 272 is then maintained up-to-date according to the operations performed on the storage device. Particularly, whenever a physical memory block is erased, the information relating to this erased physical memory block (i.e., its physical block number) is then inserted into the free list 272. Conversely, when an erased physical block is used to write data thereinto, it is removed from the free list 272.

The FTL 265 also interfaces with a service function 275 (Garbage collection service) that implements a garbage collection procedure. When the garbage collection service function 275 is invoked in respect of a specific logical memory block (for example, because both the root physical block and the leaf physical block associated with the logical block are full, so that no further data can be written into the physical memory sectors to accommodate data written into the corresponding logical memory sectors), the valid data (i.e., the most recent version of the data stored in the logical memory sectors of the logical memory block that corresponds to the root and leaf physical memory blocks) are compacted into a new root physical block.

The FTL 265 controls the physical memory space 255 through a hardware adaptation layer 285. The adaptation layer 285 exposes a command interface for reading/programming the physical pages and for erasing the physical blocks of the flash memory. The adaptation layer 285 implements different functions that are required to access the flash memory (such as a low-level driver of the flash memory, an ECC—Error Correction Code—manager, a bad blocks manager, and the like).

In an embodiment of the present invention, the FTL 265 may exploit an invalid blocks list 273. As will be more clear in the following of the present description, the invalid blocks list 273 indicates (e.g., by means of their physical block numbers) the physical blocks that are erasable. The invalid block list 273 is maintained up-to-date according to the operations performed on the storage device.

Particularly, when the garbage collection procedure is invoked in respect of a certain logical memory block (because, as mentioned above, there is no more physical memory space available for storing the data of the logical memory sectors of that logical memory block, since the root and leaf physical blocks are full or nearly full) and the valid data stored in the associated root and leaf physical memory blocks are copied into a new physical memory block, the root and leaf physical memory blocks are marked as “invalid”, to indicate that they are erasable. This marking can for example involve properly setting a flag, for example a byte 291 in the spare storage area 287 of at least one of the physical memory sectors of the physical memory blocks, e.g. the first physical memory sector of the root and leaf physical memory blocks. Information corresponding to the physical memory blocks marked as invalid (i.e., the respective physical block number) is inserted into the invalid blocks list 273. Erasure of the physical memory blocks in the invalid blocks list 273 can take place at a later time, i.e. it can be postponed to the invocation of the garbage collection procedure, and it can be expediently performed when the storage device is idle, for example when it is not accessed in read or write. After a physical memory block marked as invalid has been erased, said block is removed from the invalid blocks list 273.

Copying the valid data stored in the physical memory sectors of the root and leaf physical memory blocks into the new physical memory block involves writing corresponding physical memory sectors of the new physical memory block. In an embodiment of the present invention, while performing the garbage collection procedure, the copying of the data stored in the physical memory sectors of the root and leaf physical memory blocks that may have been marked (by the flag byte 290 being set) as deleted, in the way described in the foregoing, does not involve a write operation. Since the physical memory sectors of the new physical memory block are initially all erased, writing of the physical memory sector or sectors of the new physical memory block which will have to store the valid data of the physical memory sectors marked as deleted in the root and leaf blocks is skipped, with saving of time and power. In this way, if for example all the physical memory sectors of the root and leaf physical memory blocks containing valid data are marked as deleted, the garbage collection operation is very fast, because no write operation needs to be performed.

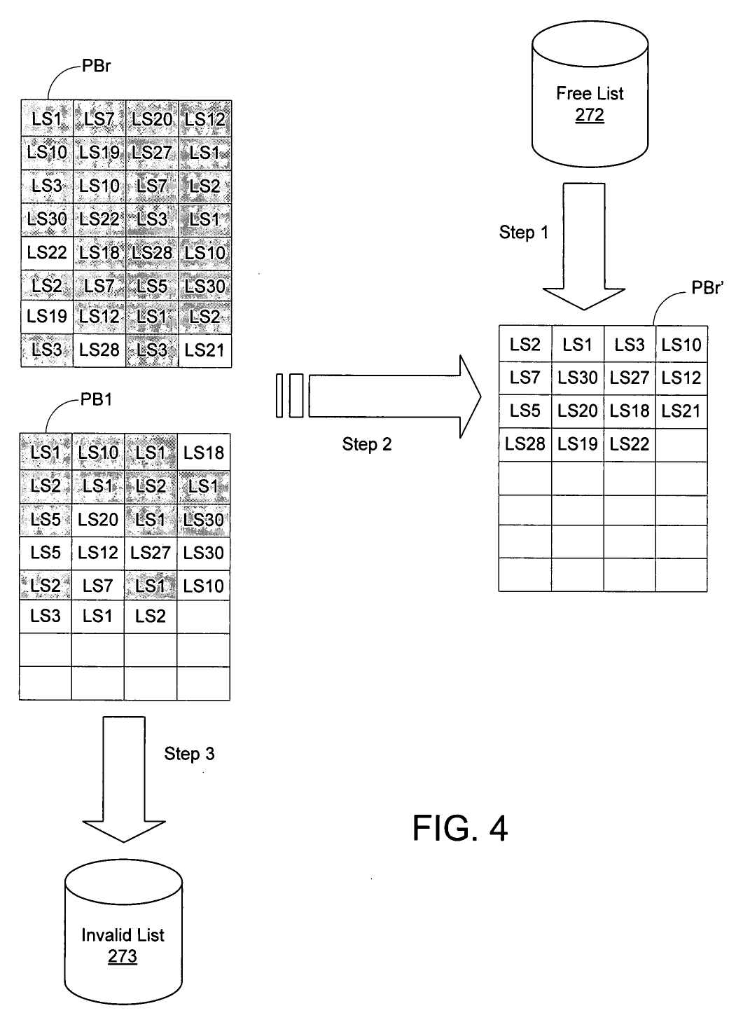

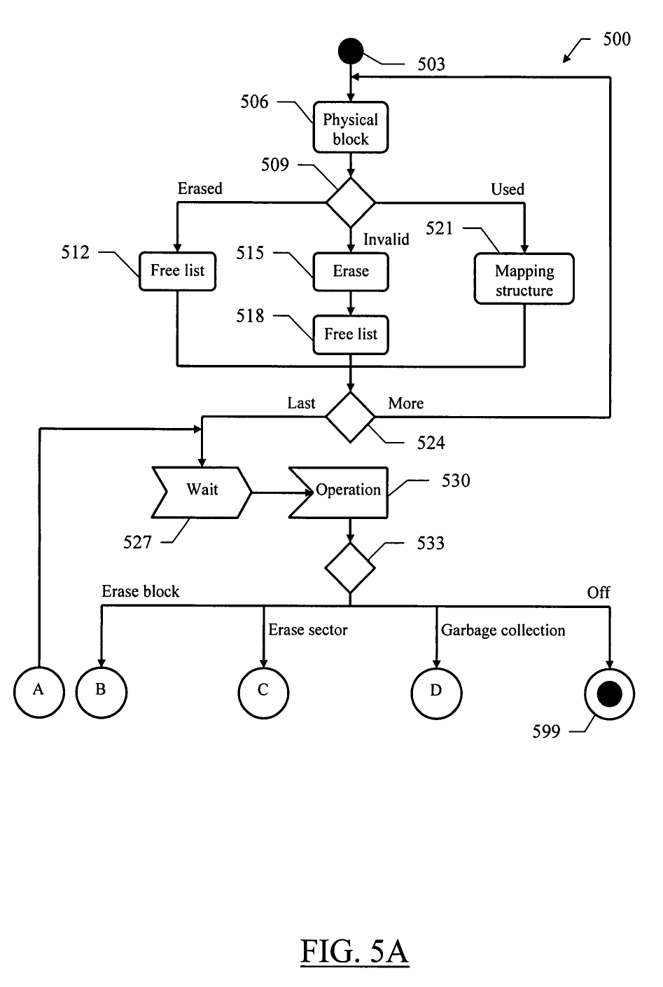

An example of how the garbage collection procedure is performed according to an embodiment of the present invention will be now described with reference FIG. 4.

Particularly, as shown in the figures, let a generic logical memory block be considered. The data of the considered logical memory block are stored in a root physical memory block PBr and a leaf physical memory block PBI. The different, successive versions of the data stored in the logical memory sectors LSi, with i=0 . . . 31, of the logical memory block have been written in succession into different physical memory sectors of the root physical block PBr and then, when the root physical memory block is full, into different physical memory sectors of the leaf physical memory block PBI. In the drawings, the most recent version of the data of each logical memory sector LSi is shown in the corresponding physical memory sector PBr, PBI with a white background. The previous versions of the logical memory sector LSi data (which are obsolete and no longer valid) are instead shown with a gray background. For example, the logical memory sector LS1 has been written at the beginning into the 1^{st} physical sector of the root physical memory block PBr (starting from the upper left corner and then moving from left to right along each row, down to the lower right corner). Next versions of the same logical memory sector LSI have been written into the 16^{th} and the 27^{th} physical memory sectors of the root physical memory block PBr, and then into the 1^{st}, the 3^{rd}, the 6^{th}, the 8^{th}, the 11^{th}, and the 19^{th} physical memory sectors of the leaf physical memory block PBI. The last and most recent version of data of the logical memory sector LS1 has been written into the 22^{nd} physical memory sector of the leaf physical memory block PBI.

According to an embodiment of the present invention, as depicted in FIG. 3, a flag byte 291 is included in the spare storage areas of the 1^{st} physical memory sectors of both the root physical memory block PBr and the leaf physical memory block PBI. The flag bytes 291 of the physical memory blocks are set, during the initialization of the storage device at its power-on, to take a first value, for example the value FFh, indicative of the fact that these memory blocks are not to be erased.

When the garbage collection procedure is invoked for compacting the physical memory space corresponding to the logical memory block, an erased physical memory block is extracted from the free memory blocks list 272 for using it as the new root physical memory block PBr′ (step 1 in the drawing). The new root physical memory block PBr′ is then removed from the free list 272. The last versions of the data of the logical memory sectors LSi that are stored in the (old) root physical memory block PBr and leaf physical memory block PBI are copied into the new root physical memory block PBr′ (step 2 in the drawing). For this purpose, the contents of the old root and leaf physical memory blocks PBr, PBI are for example scanned backward (from the end of the old leaf physical block PBI to the beginning of the old root physical memory block PBr). Each encountered logical memory sector LSi is copied into the first available physical memory sector of the new root physical block PBr′, provided that such logical memory sector is not yet present in the new root memory physical block PBr′ (in which case the encountered logical memory sector is the most recent version), while it is discarded otherwise (being a previous version thereof. At the end, the last versions of all the logical memory sectors LSi stored in the old physical memory blocks PBr, PBI are stored in the new root physical memory block PBr′ (at most filling it). In this phase, the spare area of each physical memory sector of the new root physical memory block PBr′ being programmed is set accordingly. Particularly, the spare storage area of the first physical memory sector of the new root physical memory block PBr′ stores the indication that it is the root node for the corresponding logical memory block. The mapping table is updated accordingly (so as to associate the logical block with the new root physical memory block PBr′, and each written logical sector LSi thereof with the corresponding physical memory sector of the new root physical block PBr′).

Then, the old physical memory blocks PBr, PBI are marked as invalid, for being erased at a later time. For this purpose, the flag bytes 291 included in the 1^{st} physical sectors of the old physical blocks PBr, PBI are both set to the value 00h, and the physical block numbers of the old physical blocks PBr, PBI are inserted into the invalid block list 273 (step 3 in the drawing).

At this point, from now on, the logical memory block is associated with the new root physical memory block PBr′ and possibly with a new leaf physical memory block (not shown in the Figure) extracted from the free list 272, too.

The garbage collection operations previously described with reference to the FIG. 4 may then be carried out on the new root physical memory block PBr′, and on the associated new leaf physical memory block, when these blocks are full or nearly full.

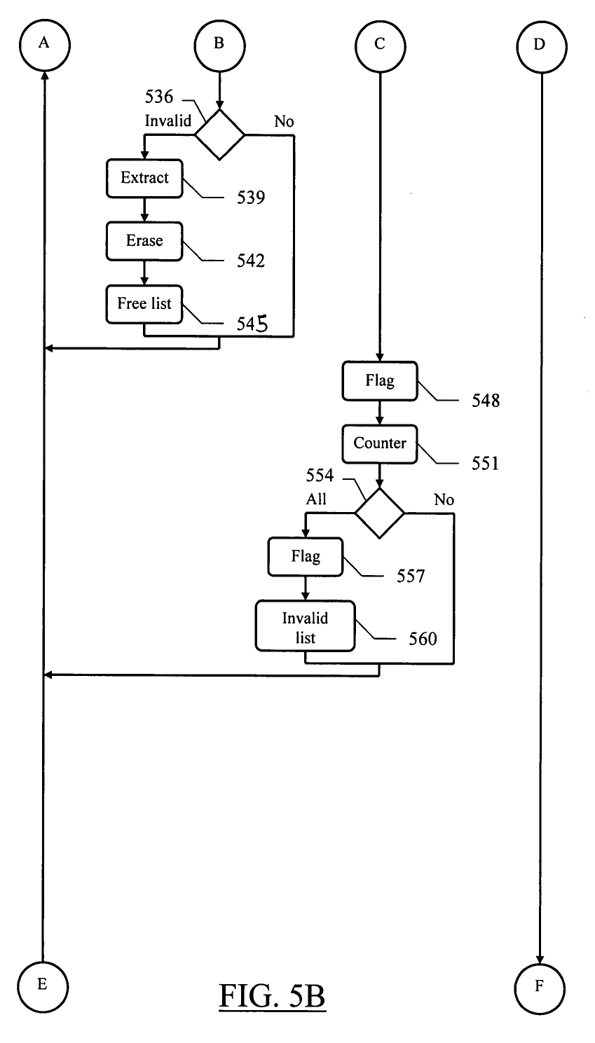

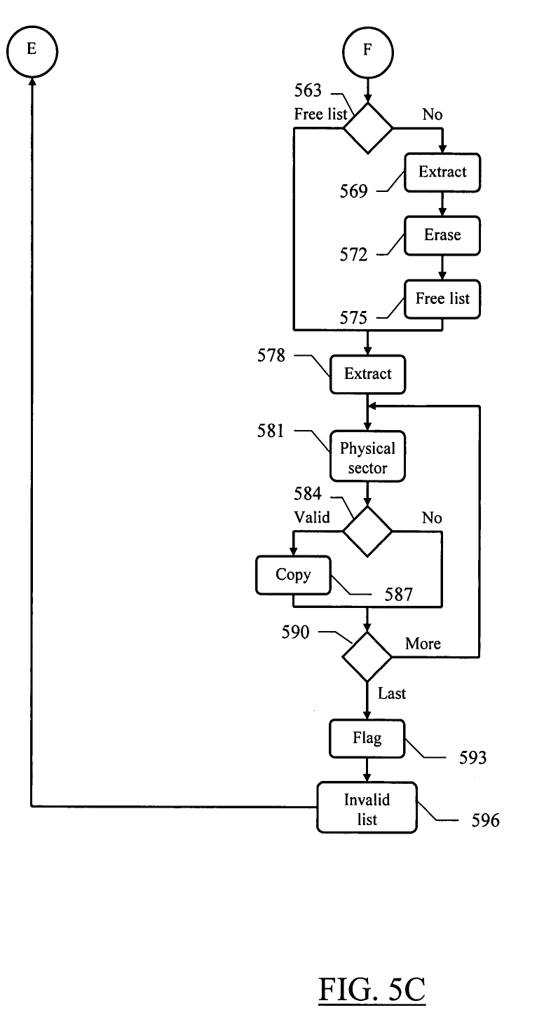

With reference now to FIGS. 5A to 5C, the logic flow of an exemplary process that can be implemented in the above-described storage device (to control its operation) is represented with a method 500.

The method begins at the black start circle 503 and enters a loop, which is executed for each physical memory block of the flash memory. The loop starts at block 506, wherein the service information of a current physical memory block—starting from the first one—is retrieved (from the spare area of its first physical memory sector). The method then branches at block 509 according to the condition of the (current) physical block—for example, as indicated by one or more flags in this spare area. Particularly, if the considered physical memory block is erased the block 512 is executed, if the physical memory block is marked as invalid (flag byte 291 set to 00h) the blocks 515-518 are executed, and if the physical memory block is used the block 521 is executed. In any case, the method then passes to block 524.

Considering now block 512, this branch is followed when the considered physical memory block is identified as erased. In this case, a new entry for the erased physical block (identified by its physical memory block number) is added to the free memory blocks list 272. The flow of activity then descends into block 524.

With reference instead to block 515, this branch is followed when the physical memory block is identified as invalid (checking the flag byte 291). In this case, the invalid physical memory block is erased. Continuing to block 518, the physical memory block (now erased) is then inserted into the free list as above. The flow of activity then descends into block 524.

Moving at the end to block 521, this branch is followed when the considered physical memory block is identified as in use. In this case, the mapping table 270 is updated accordingly. The flow of activity then descends into block 524.

Considering now block 524, a test is made to verify whether all the physical blocks of the flash memory have been processed. If not, the method returns to block 506 to repeat the same operations for a next physical block. Conversely, the storage device enters a waiting condition at block 527.

As soon as any operation is required on the storage device, the process descends into block 530. The method then branches at block 533 according to the type of the operation to be performed. For the sake of simplicity, in the following reference will be made only to the operations that are relevant to the understanding of the proposed solution. Particularly, if an erase operation of an invalid physical block is required, the blocks 536-545 (FIG. 5B) are executed. If a delete operation of the data stored in a logical memory sector is required, the blocks 548-560 (FIG. 5B) are executed. If a garbage collection procedure is invoked, the blocks 563-596 (FIG. 5C) are executed. In all cases, the method then returns to block 527 waiting for the request of a next operation. Conversely, when the storage device is switched off, the method ends at the concentric white/black stop circles 599.

Particularly, the block 536 is entered when en erase operation of an invalid physical memory block is required. Preferably, this happens when the storage device is idle (for example, periodically under the control of an idle thread of an operating system of the telephone). In this phase, a test is made to verify whether any invalid physical memory block is available in the invalid list. If so, the method passes to block 539 wherein the first invalid physical memory block is extracted from the invalid blocks list 273. The selected invalid physical memory block is then erased at block 542. Proceeding to block 545, the erased physical memory block is added to the free memory blocks list 272. The method then returns to block 527. The same point is also reached from block 536 directly when the invalid blocks list 273 is empty.

Considering now block 548 (data delete operation of a logical memory sector), the physical memory sector storing the most recent version of the data stored in the corresponding logical memory sector is identified (as indicated in the mapping table 270); the flag byte 290 in this physical memory sector is then asserted (from FFh to 00h). It should be noted that the use of flags with multiple bits, e.g. one byte, strongly reduces any risk of discarding physical memory sectors storing valid data. Indeed, the flag 290 is considered asserted only when all its bits have the logical value ‘0’, so that the probability of having all the 8 bits that take the logical value ‘0’ even when the physical memory sector stores valid data is negligible. The method then proceeds to block 551, wherein an erase counter of the corresponding logical block is incremented by 1. The erase counter (being initialized at 0) indicates the number of erased logical memory sectors of the logical memory block. A test is now made at block 554 to determine whether the erase counter has reached the total number of logical sectors of the logical memory block (i.e., 32, in the example at issue), meaning that the all the logical memory sectors have been erased. If so, the invalid block flag 291 of the root physical block and leaf physical block (if any)—associated with the erased logical memory block—are asserted at block 557. Passing to block 560, each one of these (root and leaf) physical memory blocks is added to the invalid blocks list 273. The method then returns to block 527; the same point is also reached from block 554 directly when the erase counter has a lower value (i.e., the logical sector is not erased).

With reference instead to block 563 (garbage collection procedure), the flow of activity branches according to the content of the free memory blocks list 272. Particularly, if the free memory blocks list 272 is empty, the first invalid physical memory block is extracted from the invalid blocks list 273 at block 569. The selected invalid physical memory block is then erased at block 572. Proceeding to block 575, the erased physical memory block is added to the free blocks list 272. The method then descends into block 578. The same point is also reached from block 563 directly when the invalid blocks list 273 is not empty. In this phase, the first erased physical memory block is extracted from the free memory blocks list 272 for use as the new root physical memory block of the logical memory block to be compacted.

A loop is now executed for each physical memory sector of the old root physical memory block and old leaf physical memory block associated with this logical memory block. The loop starts at block 581, wherein the (current) physical memory sector—starting from end of the leaf physical memory block and going back to the beginning of the root physical memory block—is retrieved. The method then branches at test block 584 according to the content of the physical memory sector. Particularly, if the physical memory sector stores valid data (flag 290 deasserted) for a logical memory sector that is not present yet in the new root physical memory block (being the most recent version thereof), the flow of activity passes to block 587. In this phase, the logical memory sector is copied into the first available physical memory sector of the root physical memory block. The method then descends into block 590. The same point is also reached from block 584 directly, when the flag 290 is asserted (meaning that the considered physical memory sector stores null data) or when the logical sector is already present in the new root physical memory block (meaning that the physical memory sector stores an obsolete version thereof)—so as to skip the content of the physical memory sector (not valid any longer).

Considering now block 590, a test is made to verify whether all the physical memory sectors of the leaf and root physical memory blocks have been processed. If not, the method returns to block 581 to repeat the same operations for a previous physical memory sector. Conversely, the old leaf physical memory block and the old root physical memory block are marked as invalid (by asserting the corresponding flags 291 in the spare area of their first physical memory sectors). Continuing to block 596, the (invalid) old leaf physical memory block and old root physical memory blocks are added to the invalid blocks list 273. The method then returns to block 527.

According to an embodiment of the present invention, the physical memory blocks erase operations are carried out exploiting the idle times of the storage device 120. In this way, the operations needed for creating new erased physical blocks to be inserted in the free list 272 need not be performed during the garbage collection procedure, particularly when serving a write request. Since the erase operations take a relatively long time, exploiting this solution allows drastically speeding up the operations performed during a garbage collection procedure. In other words, the solution proposed according to this embodiment of the invention allows speeding up the performance of the storage device 120 by postponing the erase operations of the physical memory blocks after the garbage collection procedure.

It is pointed out that the operations performed for marking as invalid a physical memory block, i.e., the setting of the flag bit 291 to the value FFh, are not influenced by a constraint on the maximum Number Of Partial Programming (NOP) operations. The NOP corresponds to the maximum number of program operations that can be performed on a physical memory page of memory cells of a flash memory for which it can be guaranteed that the program operation has been accomplished correctly after an erase operation. Typically, but not limitatively, a physical memory page may be submitted to a number of programming operations equal to three (NOP for a NAND flash memory with small-size memory pages) or eight (NOP for a NAND flash with large-size memory pages).Even if the first physical page of the physical memory block has already been programmed three times or eight times, the physical memory block can be marked as invalid. In fact, as discussed in the foregoing, marking a physical memory block as invalid may, in an embodiment of the present invention, call for changing the value of one of the bytes of the first physical page spare area from FFh (all ones) to 00h (all zeroes). When the NOP for the first physical page is exceeded, it may happen that the changing of each bit of the flag byte from one to zero does not succeed. Nevertheless, this is not a real problem, because a physical memory block is considered as invalid when the flag byte of the spare area of the first physical page is different from FFh, thus it suffices that one among the eight bits of the flag byte changes from one to zero. Another possible consequence of exceeding the NOP for a physical memory page is that one or more other physical memory pages of the same physical memory block may change their status (bit flipping). Even if this happens, no problems arises, because after the physical memory block is marked as invalid, the data stored therein are no longer exploited (the valid data have already been saved into the new physical block during the garbage collection procedure), thus the invalid memory block is no longer read or written before it is erased; the erase operation removes from the physical block any effect related to exceeding the NOP.

The proposed solution of exploiting the flag 290 to marking the physical memory sectors that corresponds to logical memory sectors whose data have been deleted advantageously avoids wasting any physical memory sectors for storing the erased data of the logical memory sectors (since the same logical memory sectors already used for storing the previous versions of the data of the corresponding logical memory sectors are used). As a result, the garbage collection procedures (being necessary when a write operation is required on a logical memory block having both the root and leaf physical memory blocks associated therewith that are full) is less frequent, with a beneficial impact on the performance of the storage device.

Moreover, this feature also facilitates any garbage collection procedure to be performed on a generic logical memory block (to compact its old root and leaf physical memory blocks into a new root physical memory block). Indeed, in this case only the content of the physical memory blocks storing the most recent versions of the corresponding logical memory sectors that really stores data (i.e., not deleted) need to be copied into the new root physical memory block. Conversely, the erased logical memory sectors (identified by the erase flag 290 asserted in the corresponding physical memory sector) may be skipped. This avoids copying null data into the new root physical memory block. As a result, the time taken by the garbage collection procedure is reduced (with a corresponding improvement in the performance of the storage device). Moreover, no physical sector is now used for storing the erased logical sectors. This avoids any waste of space in the new root physical block (with the above-mentioned advantages).

As an extreme case, when all the logical memory sectors of a logical memory block are erased, no physical memory sector is required for storing their data. Therefore, the garbage collection procedure may complete very quickly, without copying any data. Moreover, it is now possible to avoid allocating any new root physical memory block to the (erased) logical block.

Naturally, in order to satisfy local and specific requirements, a person skilled in the art may apply to the solution described above many logical and/or physical modifications and alterations. More specifically, although the present invention has been described in detail with reference to embodiment(s) thereof, it should be understood that various omissions, substitutions and changes in the form and details as well as other embodiments are possible. Particularly, the proposed solution may even be practiced without the specific details (such as the numerical examples) set forth in the preceding description to provide a more thorough understanding thereof. Conversely, well-known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

Particularly, the proposed solution lends itself to be implemented with equivalent methods (by using similar steps, removing some steps being non-essential, or adding further optional steps). Moreover, the steps may be performed in a different order, concurrently or in an interleaved way (at least in part).

Similar considerations apply if the storage device emulates an equivalent logical memory space (with a different number and/or size of the logical memory blocks, each one including a different number of logical memory sectors with different size). Likewise, the physical memory space of the flash memory may have a different number and/or size of the physical memory blocks, each one including physical memory pages with a different number and/or size.

Alternatively, it is possible to implement the mapping of the logical memory space on the physical memory space with different techniques. For example, by associating a tree structure with a root node and multiple child nodes with each logical sector, by storing the required information in any other way, and the like. Likewise, the garbage collection procedure may be controlled in a different way (for example, according to specific algorithms based on the current filling rate of the flash memory).

Even though in the preceding description reference has been made to a flash memory with NAND architecture, this is not to be interpreted in a limitative manner. More generally, the proposed solution lends itself to be used in a storage device based on any other flash memory (for example, of the NOR type, of the phase-change type, and the like).

Similar considerations apply if the program, which may be used to implement each embodiment of the invention is structured in a different way, or if additional modules or functions are provided. Likewise, the memory structures may be of other types, or may be replaced with equivalent entities (not necessarily consisting of physical storage media). In any case, the program may take any form suitable to be used by or in connection with any control system of the storage device, such as software, firmware, or microcode. Moreover, it is possible to provide the program on any medium being adapted to be used by the control system. The medium can be any element suitable to contain, store, communicate, propagate, or transfer the program. For example, the medium may be of the electronic, magnetic, optical, electromagnetic, infrared, or semiconductor type. Examples of such medium are the flash memory itself or a ROM (where the program can be pre-loaded), wires, wireless connections, broadcast waves, and the like. In any case, the solution according to embodiments of the present invention lends itself to be implemented with a hardware structure (for example, integrated in a chip of semiconductor material), or with a combination of software and hardware.

Likewise, the above-described architecture of the storage device is merely illustrative, and it must not be interpreted in a limitative manner.

For example, as previously mentioned, different FLASH architectures such as a NOR architecture of the matrix of memory cells may be utilized in other embodiments. Also, memory technologies other than FLASH memory having similar block erase functionality may also be utilized in embodiments of the present invention.

It should be readily apparent that the proposed structure might be part of the design of an integrated circuit. The design may also be created in a programming language; moreover, if the designer does not fabricate chips or masks, the design may be transmitted by physical means to others. In any case, the resulting integrated circuit may be distributed by its manufacturer in raw wafer form, as a bare die, or in packages. Moreover, the proposed structure may be integrated with other circuits in the same chip, or it may be mounted in intermediate products (such as mother boards).

In any case, it should be noted that the storage device may be used in any other data processing system. Further examples of such system are an MP3 player, a digital camera, a PDA, a laptop computer, and the like.

1. A method of freeing physical memory space in an electrically alterable memory that includes a plurality of physical memory blocks comprising a plurality of physical memory pages, each physical memory block being adapted to be individually erased as a whole, and which memory is used to emulate a random access logical memory space comprising a plurality of logical memory sectors by storing updated versions of a logical memory sector data into different physical memory pages, the method comprising:
causing a most recent version of multiple versions of logical memory sector data, stored in physical pages of at least one physical memory block, to be copied into an unused physical memory block;
marking the at least one physical memory block;
when the electrically alterable memory is idle, erasing the marked physical memory block.

2. The method of claim 1, wherein said marking includes setting a first flag in a spare storage area of at least one physical memory page of the physical memory block.

3. The method of claim 2, wherein said flag includes two or more bits.

4. The method of claim 1, wherein:
in case the updated version of the logical memory sector data corresponds to deleted data, marking the physical memory page storing the most recent version of the logical memory sector data without storing the updated version of the logical memory sector data into a new physical memory page.

5. The method of claim 4, wherein said marking the physical memory page includes setting a second flag in a spare storage area of said physical memory page.

6. The method of claim 5, wherein said causing the most recent version of multiple versions of logical memory sector data to be copied into an unused physical memory block includes avoiding copying the data contained in the marked physical memory page.

7. The method according to claim 1, wherein the electrically alterable memory is a flash memory of the NAND type.

8. A software program product including a medium embodying a software program, the medium being adapted to be used by a control system of a storage device based on a flash memory, wherein the software program when executed on the control system causes the control system to perform the wear leveling method according to claim 1.

9. A control system for a storage device based on an electrically alterable memory, the control system including means for performing the steps of the method according to claim 1.

10. A storage device based on an electrically alterable memory including the control system according to claim 9.

11. A data processing system including at least one storage device according to claim 10.

12. A garbage collection process for execution in a memory device including a plurality of physical memory blocks, the garbage collection process comprising:
copying valid data stored in a first physical memory block into a second physical memory block;
indicating the first physical memory block is invalid; and
after the first physical memory block is indicated as invalid, determining whether a predetermined condition of the memory device exists; and
when the predetermined condition of the memory is determined to exist, erasing the first physical memory block.

13. The garbage collection process of claim 12 wherein the predetermined condition comprises an idle condition of the memory device.

14. The garbage collection process of claim 12,
wherein the memory device is operable to emulate a random access logical memory space, the logical memory space including a plurality of logical memory sectors;
wherein each physical memory block includes a plurality of physical memory pages, the data for each logical memory sector being stored in a corresponding physical memory page; and
wherein copying valid data stored in a first physical memory block into a second physical memory block comprises storing a most recent version of the data for each memory sector stored in a corresponding physical memory page in the first physical memory block into a physical memory page in the second physical memory block.

15. The garbage collection process of claim 12 wherein each physical memory block includes at least one physical memory page that includes a flag that is set to indicate that the corresponding physical memory block is invalid, and wherein indicating the first physical memory block is invalid comprises setting the corresponding flag for the first physical memory block.

16. The garbage collection process of claim 12 wherein each physical memory page includes a portion corresponding to a flag indicating that the data stored the physical memory page corresponds to deleted data, and wherein copying valid data stored in the first physical memory block into the second physical memory block comprises setting the flag in the corresponding physical memory page in the second physical block to which the valid data is to be copied without actually copying the data stored in the corresponding physical memory page in the first physical memory block.

17. The garbage collection process of claim 12 further comprising generating an entry in an invalid physical memory block list responsive to the operation of indicating the first physical memory block is invalid, wherein the invalid physical memory block list includes an entry for all invalid physical memory blocks in the memory device.

18. The garbage collection process of claim 12 further comprising generating an entry in a free physical memory block list responsive to the operation of erasing the first physical memory block, wherein the free physical memory block list includes an entry for all erased physical memory blocks in the memory device to which data may be written.

19. A data storage device, comprising:
a memory including a plurality of physical memory blocks, each physical memory block including a plurality of physical memory pages and each block being erasable; and
a control unit coupled to the memory, the control unit operable to map a logical memory space including a plurality of logical memory blocks to a physical memory space formed by the plurality of physical memory blocks in the memory, each logical memory block including a plurality of logical memory sectors, and wherein the control unit is further operable to free storage space in the memory by copying valid data stored in a first physical memory block into a second physical memory block, indicating the first physical memory block is invalid, and, after the first physical memory block is indicated as invalid, erasing the first physical memory block when a predetermined condition of the memory exists.

20. The data storage device of claim 19 wherein the memory comprises a FLASH memory.

21. The data storage device of claim 19 wherein the predetermined condition comprises an idle state of the memory.

22. The data storage device of claim 19 wherein the control unit comprises:
a mapping table component operable to associate each logical memory block with a corresponding physical memory block and each logical memory sector with a physical memory sector corresponding to at least one physical memory page;
a free list component operable to store a list of physical memory blocks that are in an erased condition and available for have data written to them;
a garbage collection component operable to compact data stored in the physical memory by copying valid data stored in the first physical memory block into the second physical memory block;
an invalid blocks list component operable to store a list of physical blocks in the memory that are erasable but not yet erased;
a hardware adaptation layer component coupled to the memory, the hardware adaptation layer operable responsive to applied commands to function as an interface for reading, programming, and erasing data stored in physical memory blocks in the memory; and
a translation layer component coupled to the memory, mapping table component, free list component, garbage collection component, invalid list component, and the hardware adaptation layer component, the translation layer component
operable to interface with the mapping table component and apply commands to the hardware adaptation layer to read, program, and erase the data the stored in physical memory blocks in the memory, and the translation layer component further operable to interface with the free physical,
operable to control the garbage collection component to compact data stored in the physical memory blocks,
operable to add the first physical memory block to the list of blocks in the invalid block list component when the garbage collection component has copied the valid data stored in the first physical memory block into the second physical memory block;
operable when the predetermined condition exists to erase physical memory blocks contained in the list of invalid memory blocks in the invalid block list component and to remove such erased blocks from the list once the blocks have been erased, and further operable to add the erased block to the list of blocks in the free list component.

23. The data storage device of claim 22 wherein each physical memory block comprises either a root physical memory block or a root physical memory block and at least one leaf physical memory block.

24. The data storage device of claim 22 wherein each physical memory block has an associated number and wherein each list of memory blocks includes the numbers of blocks contained in the list.

25. The data storage device of claim 22 wherein the garbage collection component is operable to store a most recent version of data for each memory sector stored in a corresponding physical memory page in the first physical memory block into a physical memory page in the second physical memory block to copy valid data from the first physical memory block to the second physical memory block.

26. The data storage device of claim 22 wherein each memory block includes a spare storage area storing at least one flag indicating whether the block is invalid, erased, or in use.

27. The data storage device of claim 26 wherein each physical memory page further includes a flag indicating whether data stored in that page has been deleted.

28. The data storage device of claim 27 wherein the garbage collection component does not the actual valid data stored in a physical memory page in the first physical memory block into a physical memory page in the second physical memory block when the flag indicates that such data has been deleted.

29. The data storage device of claim 22 wherein the a hardware adaptation layer component coupled to the memory, the hardware adaptation layer operable responsive to applied commands to function as an interface for reading, programming, and erasing data stored in physical memory blocks in the memory; and

30. An electronic device, comprising:
electronic circuitry operable to perform a desired function; and
a data storage device, comprising:
a memory including a plurality of physical memory blocks, each physical memory block including a plurality of physical memory pages and each block being erasable; and
a control unit coupled to the memory, the control unit operable to map a logical memory space including a plurality of logical memory blocks to a physical memory space formed by the plurality of physical memory blocks in the memory, each logical memory block including a plurality of logical memory sectors, and wherein the control unit is further operable to free storage space in the memory by copying valid data stored in a first physical memory block into a second physical memory block, indicating the first physical memory block is invalid, and, after the first physical memory block is indicated as invalid, erasing the first physical memory block when a predetermined condition of the memory exists.

31. The electronic device of claim 30 wherein the electronic circuitry comprises mobile telephone circuitry.

32. The electronic device of claim 31 wherein the predetermined condition comprises an idle thread of an operating system of the mobile telephone circuitry.

33. The electronic device of claim 32 wherein the memory comprises a FLASH memory.

34. The electronic device of claim 30 wherein the electronic circuitry further comprises:
a processor coupled to a communication bus, the data storage device also being coupled to the communication bus;
a random access memory coupled to the communication bus;
input devices coupled to the communication bus;
output devices coupled to the communication bus; and
wireless communications circuitry coupled to the communication bus.

35. The electronic device of claim 32 wherein the control unit is further operable to immediately erase at least some of the physical memory blocks indicated as invalid when there are no erased physical memory blocks available to function as the second physical memory block.
